(19) United States
(12) Patent Application Publication
(10) Pub. No.: US 2022/0067503 A1
(43) Pub. Date: Mar. 3, 2022

(54) METHOD FOR ANALYZING CLASS SIMILARITIES IN A MACHINE LEARNING MODEL

(71) Applicant: NXP B.V., Eindhoven (NL)

(72) Inventors: Brian Ermans, 's-Hertogenbosch (NL); Gerardus Antonius Franciscus Derks, Dongen (NL); Wilhelmus Petrus Adrianus Johannus Michiels, Reusel (NL); Christine van Vredendaal, Veldhoven (NL)

(21) Appl. No.: 17/002,978

(22) Filed: Aug. 26, 2020

(51) Int. Cl. G06N 3/08; G06N 3/04

(52) U.S. Cl. CPC G06N 3/08; G06N 3/04

(57) ABSTRACT

A method is provided for analyzing a similarly between classes of a plurality of classes in a trained machine learning model (ML). The method includes collecting weights of connections from each node of a first predetermined layer of a neural network (NN) to each node of a second predetermined layer of the NN to which the nodes of the first predetermined layer are connected. The collected weights are used to calculate distances from each node of the first predetermined layer to nodes of the second predetermined layer to which the first predetermined layer nodes are connected. The distances are compared to determine which classes the NN determines are similar. Two or more of the similar classes may then be analyzed using any of a variety of techniques to determine why the two or more classes of the NN were determined to be similar.

### BACKGROUND

### Field

This disclosure relates generally to machine learning (ML), and more particularly, to a method for analyzing class similarities in a ML model.

### Related Art

Machine learning is becoming more widely used in many of today's applications, such as applications involving forecasting and classification. Generally, a machine learning (ML) model is trained, at least partly, before it is used. Training data is used for training a ML model. Machine learning models may be classified by how they are trained. Supervised learning, unsupervised learning, semi-supervised learning, and reinforcement learning are examples of training techniques. The effectiveness of a ML algorithm, which includes the model's accuracy, execution time, and storage requirements, is determined by several factors including the quality of the training data.

Trained ML models are often considered “black-boxes” by users of the models because there may be very little information available on the inner workings of the model. It would be useful to have information to help determine why an ML model makes certain predictions. For example, it may be useful to have a way to determine why an ML model mis-classifies two samples as being in the same class when the samples should have been classified in different classes. This would help a ML model designer to produce, for example, a better training dataset resulting in ML models that can more accurately classify input samples.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a system for training a ML model.

FIG. 2 illustrates a neural network in accordance with an embodiment.

FIG. 3 illustrates a portion of the neural network of FIG. 2.

FIG. 4 illustrates a method for analyzing similarities in a plurality of classes in a ML model in accordance with an embodiment.

FIG. 5 illustrates a processor useful for implementing the method of FIG. 4 in accordance with an embodiment.

### DETAILED DESCRIPTION

Generally, there is provided, a method for analyzing a ML model. In one embodiment, the ML model includes a neural network (NN). The NN is trained on a training data set to classify samples, for example, images. The NN includes layers of nodes connected together. Some or all the connections between the nodes are weighted. In one embodiment of the method, the weights of the connections between nodes of a last intermediate layer and nodes of an output layer are collected. Each output node represents one class of samples. In one embodiment of the method for analyzing, distances between the last intermediate nodes and the output nodes are calculated using the weights. In a comparison of output node distances, one pair of output nodes having a shorter calculated distance between them indicate a greater similarity between the pair of output nodes than another pair of output nodes that has a longer distance.

The method analyzes similarities or differences between classes instead of differences between individual samples. Determining why a ML model determines two classes are similar may provide insight into understanding why the ML model mis-classifies an individual sample An advantage of the method is that the method can be used without having the training data set available. However, if a training data set is available, this method can be a filter to help determine why specific samples are misclassified using other methods, such as Grad-CAM (gradient class-activation map).

In accordance with an embodiment, there is provided, in a trained machine learning model (ML) having a neural network (NN) for classifying an input sample into a class of a plurality of classes, a method for analyzing a similarly between classes of the plurality of classes, the method including: collecting weights of connections from each node of a first predetermined layer of the NN to each node of a second predetermined layer of the NN to which the nodes of the first predetermined layer are connected; using the collected weights, calculating distances from each node of the first predetermined layer to nodes of the second predetermined layer to which the first predetermined layer nodes are connected; comparing the distances to determine which classes the NN determines are similar; and enabling an analysis of the two or more similar classes to determine why the two or more classes of the NN were determined to be similar. The first predetermined layer may be a last intermediate layer and the second predetermined layer is an output layer of a neural network. Calculating the distances may further include calculating the distances using one or more of Euclidian distance, Manhattan distance, or Hamming distance. The shortest distances between classes may indicate the greatest similarities between the classes. The method may further include ranking the distances in an order of shortest to longest. The method may further include using a confusion matrix to find similar classes the ML model most often confuses. The analysis of the two or more similar classes may further include finding unwanted similarities between two or more classes. Calculating the distances may further include calculating the distances using the collected weights plus biases of each node. The method may further include using an interpretability method to visualize samples of the one or more similar classes. The interpretability method may include Grad-CAM (gradient class-activation map). The trained ML model may include a neural network.

In accordance with another embodiment, there is provided, in a trained machine learning model (ML) having a neural network (NN) for classifying an input sample in one class of a plurality of classes, a method for analyzing a similarly between classes of the plurality of classes, the method including: collecting weights of connections from last intermediate nodes of a last intermediate layer of the NN to each output node of an output layer of the NN to which the last intermediate nodes are connected, wherein each output node of the output layer corresponds to a class of the plurality of classes; using the collected weights, calculating distances from each of the last intermediate nodes to the output layer nodes to which the last intermediate nodes are connected; comparing the distances to determine which classes the NN determines are similar; and enabling an analysis of the two or more similar classes to determine what features of samples the NN used to make a classification in the two or more similar classes. Calculating the distances may further including calculating the distances using one or more of Euclidian distance, Manhattan distance, or Hamming distance. The shortest distances between classes indicate the greatest similarities between the classes. The method may further include ranking the distances in an order of shortest to longest. The method may further include using a confusion matrix to find similar classes the ML model most often confuses. The analysis of the two or more similar classes may further include finding unwanted similarities between the two or more classes. Calculating the distances may further include calculating the distances using the collected weights plus biases of each node. The method may further include using an interpretability method to visualize samples of the one or more similar classes. The interpretability method may include Grad-CAM (gradient class-activation map).

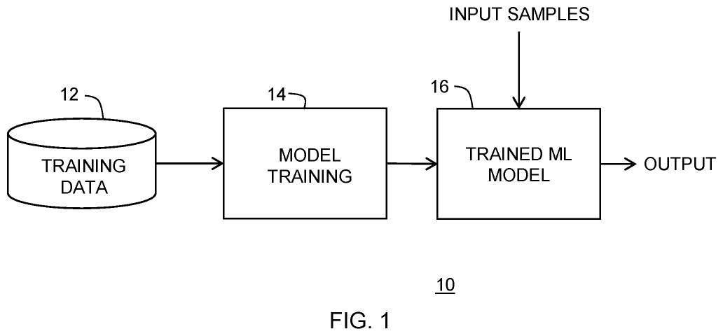

FIG. 1 illustrates system 10 for training a ML model. System 10 includes a labeled set of ML training data 12, model training block 14, and resulting trained ML model 16. In one embodiment, system 10 is implemented as a computer program stored on a non-transitory medium comprising executable instructions.

One example embodiment includes a neural network (NN) algorithm used in the ML model to classify images. There are a number of NN algorithms available. One well known NN is known as VGG16. Many other neural networks are available. Also, various training datasets can be acquired to train an ML model, such as for example, the ImageNet data set by Stanford Vision Labs, Stanford University, and Princeton University.

Convolutional neural networks are well known. Generally, a neural network includes an input layer, one or more output layers, and one or more hidden layers between the input and output layers. Each layer can have any number of nodes, or neurons. Typically, each of the nodes includes an activation function. There can be any number of hidden layers. Each hidden layer can include any number of nodes and concludes with a last hidden or last intermediate layer before the output layers. There can be any number of output nodes in the output layer. Typically, the number of output nodes is equal to the number of classes to classify. An input sample is provided at the input layer and propagates through the network to the output layers. The propagation through the network includes the calculation of values for the layers of the neural network, including the intermediate values for the intermediate layers used by the described embodiments. Typically, weights and biases are applied at each of the nodes of the neural network. Generally, a weight at a node determines the steepness of the activation function and the bias at a node delays a triggering of the activation function. One or more output signals are computed based on a weighted sum of the inputs and outputs from the output nodes. Also, the activation functions may include non-linear activation functions. The activation functions, the weights, the biases, and the input to a node defines the output. Training the ML model with training dataset 12 results in trained ML model 16. Trained ML model 16 may then be used to classify input samples, labeled “INPUT SAMPLES” in FIG. 1 and output a classification of the input sample labeled “OUTPUT.”

Even though a ML model might be carefully trained, the ML model may still make prediction mistakes. The method as described herein provides a method for further understanding the mechanisms behind prediction results provided by ML models. Specifically, the method can help a ML model designer understand why a model made a prediction, either a correct prediction or an incorrect prediction. The information learned from the method can be used to compile better training data and to design better and safer systems with ML models.

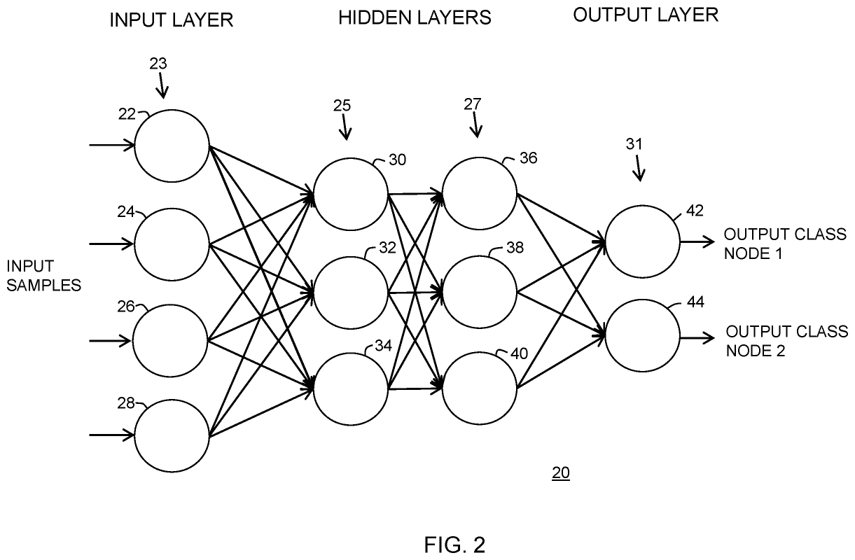

FIG. 2 illustrates neural network 20 in accordance with an embodiment.

Generally, with neural networks, there are many possible configurations of nodes and connections between the nodes. Neural network 20 is only one simple embodiment for illustrating and describing an embodiment of the invention. Other embodiments can have a different configuration with a different number of layers and nodes. Each layer can have any number of nodes, or neurons. Neural network 20 includes input layer 23, hidden layers 25 and 27, and output layer 31. Input layer 23 includes nodes 22, 24, 26, and 28, hidden layer 25 includes nodes 30, 32, and 34, hidden layer 27 includes nodes 36, 38, and 40, and output layer 31 includes nodes 42 and 44. Hidden layer 27 is considered a last intermediate layer of neural network 20. Each of the nodes in output layer 31 corresponds to a prediction class and provides an output classification OUTPUT CLASS NODE 0 and OUTPUT CLASS NODE 1. In other embodiments, there can be a different number of layers and each layer may have a different number of nodes. As mentioned above, the number of output nodes corresponds to the number of classes, where each output node represents one of the classes. All the nodes in the layers are interconnected with each other. There are many variations for interconnecting the nodes. The layers illustrated in the example of FIG. 2 may be considered fully connected because a node in one layer is connected with all the nodes of the next layer. In the drawings, arrows indicate connections between the nodes. The connections are weighted by training and each node includes an activation function.

During training, input samples labeled “INPUT SAMPLES” are provided to input layer 23. Weights and biases are applied at each of the nodes of the neural network and are adjusted by the training. That is, a strength of the weights of the various connections is adjusted during training based on the input samples from a training data set. The input sample is provided at the input layer and propagated through the network to the output layers. The propagation through the network includes the calculation of values for the layers of the neural network, including intermediate values for the hidden intermediate layers. The outputs of the intermediate hidden layers can be changed by changing their weights and biases. Generally, a weight at a node determines the steepness of the activation function and the bias at a node delays a triggering of the activation function. One or more output signals are computed based on a weighted sum of the inputs and outputs from the output nodes. The activation functions, the weights, the biases, and the input to a node defines the output. Back propagation in the reverse direction through the layers is also possible.

Generally, in a NN, all weights and layers are used for making the predictions of all classes. However, the weights and biases of the output layer nodes are typically only processed by the output node corresponding to a single class. The output nodes perform calculations using the inputs coming from the penultimate layer and therefore make the final distinction between classes.

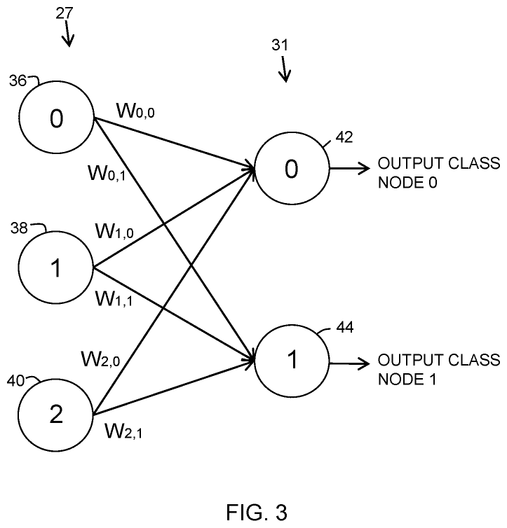

FIG. 3 illustrates last intermediate layer 27 and output layer 31 of the neural network of FIG. 2 in more detail and in accordance with an embodiment. Note that only two output nodes are illustrated and discussed for the purposes of simplicity and clarity. Depending on the application, there may be many more output nodes. Each output node has three connections, one from each of the last intermediate nodes. All the weights connected to an output node are treated as a vector. Each output node is associated with a class. The weights connected to node 42 are labeled W_{0,0}, W_{1,0}, and W_{2,0} and comprise the weight vector for node 42. The weights connected to node 44 are labeled W_{0,1}, W_{1,1}, and W_{2,1} and comprise the weight vector for node 44. The first number indicates which intermediate node and the second number indicates the output node number. The weights in all weight vectors for each output node should be listed in the same order. The weight vectors are then treated as points in space in which the distances between output class node vectors can be determined. The classes that have a short distance between each other are treated as more similar than classes that have a longer distance between each other. Classes with long distances between them are considered to be low in similarity. The distances from one class to all other classes can be ranked. Also, the distances for a specific class can be ranked so that the closest class has the first or highest similarity ranking, and the class furthest away has the last or lowest similarity ranking. In addition, the distances can be normalized.

The described method provides insight in what classes a NN considers or treats similarly. Finding similarities between classes can also be used to find unwanted similarities between classes, which are commonly called biases. The biases are sometimes misclassified by the NN. Also, the similarities between classes can be used to find very atypical edge-cases (outliers), where a sample is predicted as a class having low similarity. In addition, the similarities can be used as a filter for selecting samples to visualize with interpretability methods such as, but not limited to, Grad-CAM (gradient class-activation map) or another interpretability method. In another embodiment, the method may be extended to other layers of the NN for a more detailed analysis of the NN and training data set by determining class similarity of various layers in the NN architecture. This may provide insight into which layers in a NN distinguish which classes.

In most types of ML algorithms, classification is done using a dense output with one neuron, or node, for each class to classify and output a class corresponding to an input sample. These neurons are connected to the previous layer in the network via weights (for each output neuron one weight to each neuron in the previous layer). The weights of each output neuron from the previous layer are stored as a vector. For example, as discussed above, a weight vector for node 42 would include weights W_{0,0}, W_{1,0}, and W_{2,0}. For each output node, which corresponds to a class, such a vector is constructed. The distance between the vectors can be calculated with any conventional distance metric such as, but not limited to, the Euclidian distance, Manhattan distance, and Hamming distance. Often in a NN, a bias is implemented as well. In the distance calculations the bias of the output node can be considered in the distance calculation by adding the implemented bias to each weight or adding the implemented bias divided by the number of classes to each weight or by just ignoring the implemented bias. The implemented bias is added to the weighted sum of the inputs. Alternative methods for calculating the distances can also be used.

A ML model might be specifically designed around the herein described method in order to produce better results, although this is not required. The output of the layer before the output layer may be normalized to ensure that the activations of all classes are within a similar range. The implemented bias could also be removed from the output nodes so that the implemented bias does not need to be considered for the similarity calculation.

As described, if the distance between two classes is relatively small, this suggests that the classes are very similar. If the distance is much larger, the classes are not similar and may be very distinct from each other. The information gathered from this method of determining class similarity can be used to analyze the training dataset, the ML model itself, or individual misclassifications of the ML model.

Finding similarities between classes can be used to find unwanted similarities between classes, which are also commonly called biases. The unwanted biases are sometimes misclassified by the NN. Also, the similarities between classes can be used to find very atypical edge-cases (outliers), where a class is predicted as a very different class and has low similarity to another class. In addition, the similarities can be used as a filter for selecting samples to visualize with interpretability methods such as, but not limited to, Grad-CAM (gradient class-activation map) or other interpretability method such as described in patent application Ser. No. 16/795,774. Patent application Ser. No. 16/795,774, filed Feb. 20, 2020 by Ermans et al. and entitled “Method For Analyzing A Prediction Classification In A Machine Learning Model” describes a method of analyzing the classification of individual samples. The herein described method can be used as a “filter” to select samples to analyze using the above cited patent application. If a particular sample is classified as a class that is very similar to the target class (e.g., a monitor classified as desktop computer), that misclassification is probably of lower interest for the user compared to a misclassification that is very distinct (e.g., a monitor classified as a bath towel).

Typically, as described above, each output layer node is specific to a class and distances between the last intermediate nodes and the output nodes are calculated using the weights to determine similarity between classes. However, in another embodiment, it is possible that relationships between nodes or other layers determine class similarities. The method may be extended to the other layers of the NN for a more detailed analysis of the NN and training data set by determining class similarity of various layers in the NN architecture. This may provide insight into which layers in a NN distinguish which classes.

The neural network VGG16 was trained with the ImageNet training data set and the described method of determining class similarity was applied. In one example of classification similarity, the inventors found the most similar class to the ox class is the oxcart class. This suggests the ML model uses features from oxen images when classifying an oxcart, probably because pictures of oxcarts often include the oxen themselves. It is up to the user whether this behavior of the trained ML model is desirable, but using the method gives insight into the fact that the class oxcart is not merely trained on the cart, but also on the ox. As another example, a promontory class is the most similar class to a beacon class. This is not very surprising, as beacons are often built on promontories, but again this may indicate a bias. The inventors found that beacons are not only classified as beacons because of their construction, but also the landscape in which they are placed. Another example is the entertainment center class, which is closest to the bookcase class. Upon inspection of the pictures used for training the model, it can be seen that many pictures of entertainment centers also include bookcases. One way to improve the training may be to crop the bookcases from these samples to focus the model on identifying important features of an entertainment system.

This method can be combined with a typical confusion matrix that described how often one class is misclassified as another class. Classes that are often misclassified and are similar should be presented to the user first. Turning again to the ImageNet data set trained on neural network VGG16 are many problematic class pairs. A sampling of the inventors' findings is shown in the table below:

| Similarity | Pair of images |
|---|---|
| 1 | Beagle_as_Basset Hound |
| 1 | cello_as_violin |
| 1 | monitor_as_CRT screen |
| 1 | trolleybus_as_tram |
| 2 | threshing machine_as_tractor |
| 2 | tiger shark_as_hammerhead shark |
| 2 | grille_as_pickup truck |
| 3 | desktop computer_as_desk |
| 3 | semi-trailer truck_as_garbage truck |
| 3 | convertible_as_pickup truck |
| 4 | chain_as_necklace |
| 4 | boathouse_as_lakeshore |
| 9 | Bullmastiff_as_Great Dane |
| 9 | computer mouse_as_desk |
| 19 | CRT screen_as_desk |
| 65 | comic book_as_jigsaw puzzle |

In the table above, the similarity number is a ranking based on a comparison of the calculated distances. A low number indicates a high level of similarity between classes and a high number indicates a lower level of similarity. By enhancing the described method with the confusion matrix, not only are similar classes found, but similar classes that the model most often confuses can be found. This information may be useful when making improvements the training dataset or improving the ML model itself. Depending on the application, for some classes it might be important not to be misclassified. Finding similar classes to misclassified classes gives more insight into the workings of the model and may aid in building trust in the ML model.

The trained ML model may fail to properly classify classes of samples because the training dataset may not provide clear differences between the samples. Also, the model might fail to distinguish the samples or there may be no conceptual difference at all in practice. It is up to the model developer to judge in which of these categories all pairs fall. In addition, classes that are very distinct from each other may end up being misclassified anyway. The described method may provide additional insight into obscure edge cases, which may be especially important for safety critical applications.

Two classes may share many features after the convolutional layer, but this feature overlap may vanish in the fully connected layers because the features are combined in the fully connected layers. It might be of interest for the user of the network to understand where this distinction occurs. In one embodiment, to measure the distance between two classes in an earlier layer of a neural network, a second neural network may be created. To create the second NN, first copy the first L layers from a target neural network that provided the samples to be analyzed and connect the copied first L layers to the last layer of the target network. That is, remove all layers between L and the last layer of the target NN. All nodes in layer L get an arc, or connection, to all nodes in the last layer. The values of all weights in the NN are frozen so that their values cannot change, except for the values of those weights between layer L and the last layer. These weights are then trained using the same training set that was used to train the target NN. A distance between classes can then be calculated in the new second NN as described herein. The calculated distances between nodes of the output layer are then analyzed. If the class similarity results of the second NN are different from the results of the target NN, then the layers preceding the output layer may be the reason for the difference instead of the output layer. Likewise, if the class similarity results of the second NN are similar to the results of the target NN, it shows that the layers preceding the output layer in the second NN do not influence the prediction any differently than the target NN.

Depending on the implementation of the invention, the information gained from the invention might be used to improve a ML training dataset and thereby improve the quality of a resulting trained model. Also, the method for analyzing class similarities may be automated. The described method may be used to improve performance of a neural network and/or a training dataset for a ML model. In addition, the invention can be used to select the best candidates out of multiple neural networks. Certain constraints or desired similarities are determined, and models are selected based on those constraints. These constraints can be determined automatically or manually. For example, in a safety critical application, An ML designer might set a constraint on the acceptable similarity between the class “stop sign” and the class “speed limit sign”. The ML designer or an automated system can then train models until at least one model is found that matches the constraints.

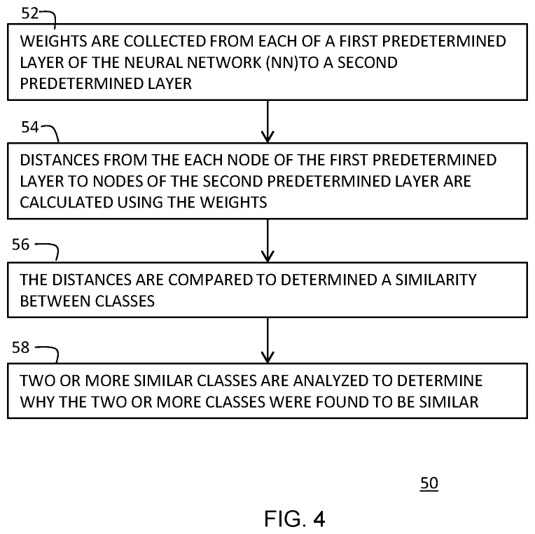

FIG. 4 illustrates method 50 for analyzing similarities in a plurality of classes in a ML model in accordance with an embodiment. In one embodiment, method 50 is performed in a trained ML model for classifying an input sample into one class of a plurality of classes. At step 52, weights of connections from each node of a first predetermined layer of the NN to each node of a second predetermined layer of the NN to which the nodes of the first predetermined layer are connected are collected. At step 54, the collected weights are used to calculate distances from each node of the first predetermined layer to nodes of the second predetermined layer to which the first predetermined layer nodes are connected. The distances between the nodes of the first and second layers are compared to determine which classes the NN determines are similar. Two or more similar classes can then be analyzed to determine why the NN found these classes to be similar.

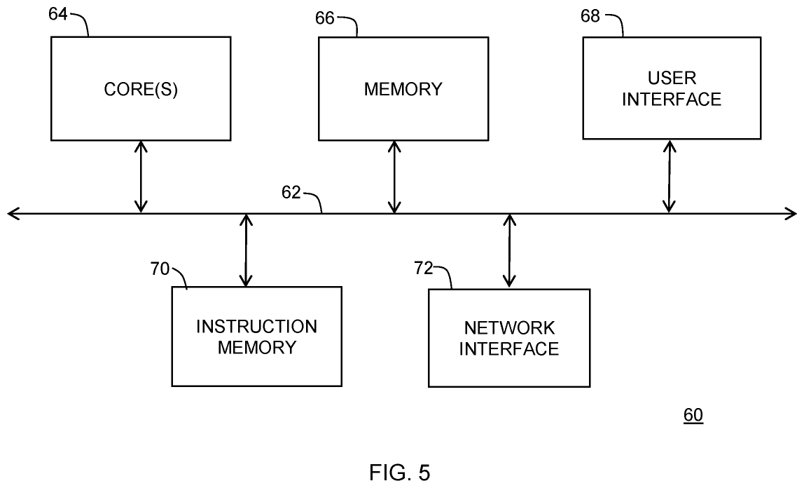

FIG. 5 illustrates data processing system 60 for use in implementing the described system and method in accordance with an embodiment. Data processing system 60 may be implemented on one or more integrated circuits. Data processing system 60 includes bus 62. Connected to bus 62 is one or more processor cores 64, memory 66, user interface 68, instruction memory 70, and network interface 72. The one or more processor cores 64 may include any hardware device capable of executing instructions stored in memory 66 or instruction memory 70. For example, processor cores 64 may execute the machine learning algorithms used for training and operating an ML model. Processor cores 64 may be, for example, a microprocessor, field programmable gate array (FPGA), application-specific integrated circuit (ASIC), or similar device. Processor cores 64 may be implemented in a secure hardware element and may be tamper resistant.

Memory 66 may be any kind of memory, such as for example, L1, L2, or L3 cache or system memory. Memory 66 may include volatile memory such as static random-access memory (SRAM) or dynamic RAM (DRAM), or may include non-volatile memory such as flash memory, read only memory (ROM), or other volatile or non-volatile memory. Also, memory 66 may be implemented in a secure hardware element. Alternately, memory 66 may be a hard drive implemented externally to data processing system 60. In one embodiment, memory 66 is used to store weight matrices for an ML model.

User interface 68 may be connected to one or more devices for enabling communication with a user such as an administrator. For example, user interface 68 may be enabled for coupling to a display, a mouse, a keyboard, or other input/output device. Network interface 72 may include one or more devices for enabling communication with other hardware devices. For example, network interface 72 may include, or be coupled to, a network interface card (NIC) configured to communicate according to the Ethernet protocol. Also, network interface 72 may implement a TCP/IP stack for communication according to the TCP/IP protocols. Data samples for classification may be input via network interface 72, or similar interface. Various other hardware or configurations for communicating are available.

Instruction memory 70 may include one or more machine-readable storage media for storing instructions for execution by processor cores 64. In other embodiments, both memories 66 and 70 may store data upon which processor cores 64 may operate.

Memories 66 and 70 may also store, for example, encryption, decryption, and verification applications. Memories 66 and 70 may be implemented in a secure hardware element and be tamper resistant.

Various embodiments, or portions of the embodiments, may be implemented in hardware or as instructions on a non-transitory machine-readable storage medium including any mechanism for storing information in a form readable by a machine, such as a personal computer, laptop computer, file server, smart phone, or other computing device. The non-transitory machine-readable storage medium may include volatile and non-volatile memories such as read only memory (ROM), random access memory (RAM), magnetic disk storage media, optical storage medium, flash memory, and the like. The non-transitory machine-readable storage medium excludes transitory signals.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. In a trained machine learning model (ML) having a neural network (NN) for classifying an input sample into a class of a plurality of classes, a method for analyzing a similarly between classes of the plurality of classes, the method comprising:
collecting weights of connections from each node of a first predetermined layer of the NN to each node of a second predetermined layer of the NN to which the nodes of the first predetermined layer are connected;
using the collected weights, calculating distances from each node of the first predetermined layer to nodes of the second predetermined layer to which the first predetermined layer nodes are connected;
comparing the distances to determine which classes the NN determines are similar; and
enabling an analysis of the two or more similar classes to determine why the two or more classes of the NN were determined to be similar.

2. The method of claim 1, wherein the first predetermined layer is a last intermediate layer and the second predetermined layer is an output layer of a neural network.

3. The method of claim 1, wherein calculating the distances further comprises calculating the distances using one or more of Euclidian distance, Manhattan distance, or Hamming distance.

4. The method of claim 1, wherein the shortest distances between classes indicate the greatest similarities between the classes.

5. The method of claim 1, further comprising ranking the distances in an order of shortest to longest.

6. The method of claim 1, further comprising using a confusion matrix to find similar classes the ML model most often confuses.

7. The method of claim 1, wherein the analysis of the two or more similar classes further comprises finding unwanted similarities between two or more classes.

8. The method of claim 1, wherein calculating the distances further comprises calculating the distances using the collected weights plus biases of each node.

9. The method of claim 1, further comprising using an interpretability method to visualize samples of the one or more similar classes.

10. The method of claim 9, wherein the interpretability method comprises Grad-CAM (gradient class-activation map).

11. The method of claim 1, wherein the trained ML model comprises a neural network.

12. In a trained machine learning model (ML) having a neural network (NN) for classifying an input sample in one class of a plurality of classes, a method for analyzing a similarly between classes of the plurality of classes, the method comprising:
collecting weights of connections from last intermediate nodes of a last intermediate layer of the NN to each output node of an output layer of the NN to which the last intermediate nodes are connected, wherein
each output node of the output layer corresponds to a class of the plurality of classes;
using the collected weights, calculating distances from each of the last intermediate nodes to the output layer nodes to which the last intermediate nodes are connected;
comparing the distances to determine which classes the NN determines are similar; and
enabling an analysis of the two or more similar classes to determine what features of samples the NN used to make a classification in the two or more similar classes.

13. The method of claim 12, wherein calculating the distances further comprises calculating the distances using one or more of Euclidian distance, Manhattan distance, or Hamming distance.

14. The method of claim 12, wherein the shortest distances between classes indicate the greatest similarities between the classes.

15. The method of claim 12, further comprising ranking the distances in an order of shortest to longest.

16. The method of claim 12, further comprising using a confusion matrix to find similar classes the ML model most often confuses.

17. The method of claim 12, wherein the analysis of the two or more similar classes further comprises finding unwanted similarities between the two or more classes.

18. The method of claim 12, wherein calculating the distances further comprises calculating the distances using the collected weights plus biases of each node.

19. The method of claim 12, further comprising using an interpretability method to visualize samples of the one or more similar classes.

20. The method of claim 19, wherein the interpretability method comprises Grad-CAM (gradient class-activation map).
